(19) United States
(12) Patent Application Publication
(10) Pub. No.: US 2006/0196872 A1
(43) Pub. Date: Sep. 7, 2006

(54) Fan oscillating device

(76) Inventor: Cheng-Kuang Yan, Kaohsiung Hsien (TW)

Correspondence Address: HARNESS, DICKEY, & PIERCE, P.L.C, 7700 BONHOMME, STE 400, ST. LOUIS, MO, 63105, US

(21) Appl. No.: 11/364,925

(22) Filed: Mar. 1, 2006

(30) Foreign Application Priority Data
Mar. 2, 2005 (TW) 094106185

(51) Int. Cl. H05B 6/78

(52) U.S. Cl. 219/753

(57) ABSTRACT

A fan-oscillating device includes a housing unit mounted to a fan head, a control rod movable between an engagement position and a disengagement position, and a rotatable wheel rotatable on the housing unit only when the control rod is disposed in the engagement position. A link-connecting member is disposed rotatably on the rotatable wheel, and has an eccentric portion. A link has two ends connected respectively and pivotally to the fan head and the eccentric portion. When the control rod is rotated, the link-connecting member rotates relative to the rotatable wheel so as to adjust a distance between the eccentric portion of the link-connecting member and a rotating axis of the rotatable wheel, thereby resulting in a change to an oscillation angle of the fan head.

### CROSS-REFERENCE TO RELATED APPLICATION

This application claims priority of Taiwanese Application No. 094106185, filed on Mar. 2, 2005.

### BACKGROUND OF THE INVENTION

1. Field of the Invention

This invention relates to a fan-oscillating device, and more particularly to a fan-oscillating device that is operable to adjust the oscillation angle of a fan head.

2. Description of the Related Art

Referring to FIG. 1, a conventional fan-oscillating device includes a control device 1 disposed behind a fan head 11. The control device 1 includes a motor seat 111, a support member 112 for supporting the motor seat 111, and a motor 113 disposed within the motor seat 111. The motor 113 is provided with a motor shaft 114. The control device 1 further includes a housing 13 disposed fixedly on the motor seat 111, an operation mechanism 14, a driving gear 15 connected to the operation mechanism 14, a swing member 16, and a link 17 having two ends connected respectively and pivotally to the swing member 16 and the support member 112. The operation mechanism 14 includes a movable control rod 141, a driven gear 142 engaging a worm rod portion of the motor shaft 114, a pull rod 140 movable synchronously with the control rod 141, and a clutch unit (not shown) disposed between the driven gear 142 and the pull rod 140. The pull rod 140 is formed with a gear portion 143 engaging the driving gear 15. The swing member 16 has a pivot portion 161 connected pivotally to the link 17, and a swing portion 162 connected to the driving gear 15.

When the control rod 141 and the pull rod 140 are pulled upwardly, the clutch unit moves to a disengagement position. As such, the motor shaft 114 rotates the driven gear 142. However, since the transmission line between the driven gear 142 and the pull rod 140 is interrupted, the pull rod 140, the driving gear 15, and the swing member 16 cannot rotate.

When the control rod 141 and the pull rod 140 are pressed downwardly, the clutch unit moves to an engagement position so as to rotate the pull rod 140, the driving gear 15, and the swing member 16 through rotation of the motor shaft 114 and the drive gear 142. Hence, the link 17 cooperates with the swing member 16 so as to oscillate the fan head 11.

A drawback of the aforesaid conventional fan-oscillating device 1 is that the oscillation angle of the fan head 11 cannot be adjusted.

### SUMMARY OF THE INVENTION

The object of this invention is to provide a fan-oscillating device that is operable to adjust the oscillation angle of the fan head.

According to this invention, a fan-oscillating device includes a housing unit mounted to a fan head, a control rod movable between an engagement position and a disengagement position, and a rotatable wheel rotatable on the housing unit only when the control rod is disposed in the engagement position. A link-connecting member is disposed rotatably on the rotatable wheel, and has an eccentric portion. A link has two ends connected respectively and pivotally to the fan head and the eccentric portion. When the control rod is rotated, the link-connecting member rotates relative to the rotatable wheel so as to adjust a distance between the eccentric portion of the link-connecting member and a rotating axis of the rotatable wheel, thereby resulting in a change to an oscillation angle of the fan head.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a partly sectional, perspective view of a conventional fan-oscillating device;

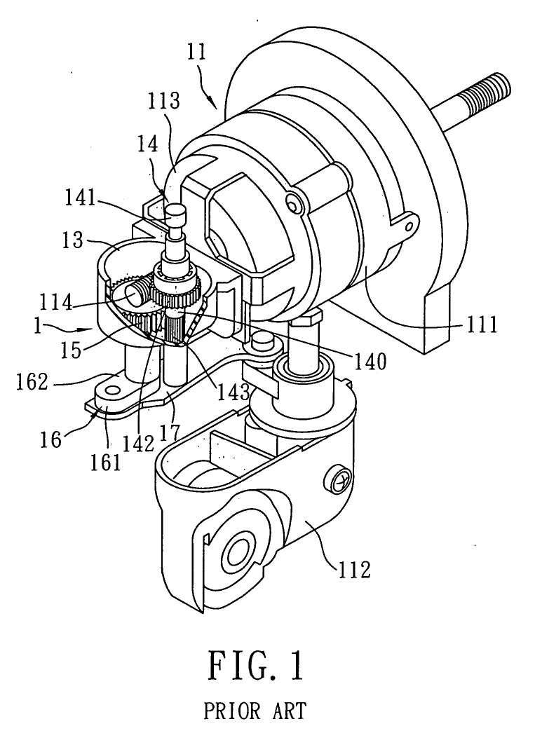

FIG. 2 is a perspective view of the preferred embodiment of a fan-oscillating device according to this invention;

FIG. 3 is a partly sectional, fragmentary exploded perspective view of the preferred embodiment;

FIG. 4 is a sectional view of the preferred embodiment, illustrating an engagement position of a control rod;

FIG. 5 is a schematic fragmentary view of the preferred embodiment, illustrating engagement between a driving gear and a driven gear and between a spur gear and an annular toothed portion of a first drive member;

FIG. 6 is a sectional view of the preferred embodiment, illustrating a disengagement position of the control rod;

FIG. 7 is a fragmentary exploded perspective view of the preferred embodiment, illustrating the structures of a precompressed torsional spring, as well as first and second drive gears;

FIGS. 8 and 9 are schematic bottom views of the preferred embodiment, illustrating how the oscillation angle of a fan head is adjusted;

FIG. 10 is a fragmentary schematic side view of the preferred embodiment, illustrating an uncompressed position of the torsional spring between the first and second drive gears;

FIG. 11 is a fragmentary schematic side view of the preferred embodiment, illustrating a compressed position of the torsional spring between the first and second drive gears;

FIG. 12 is a fragmentary schematic side view of the preferred embodiment, illustrating a change in the torsional spring when the first drive gear rotates counterclockwise; and

FIG. 13 is a fragmentary schematic side view of the preferred embodiment, illustrating a change in the torsional spring when the first drive gears rotates clockwise.

### DETAILED DESCRIPTION OF THE PREFERRED EMBODIMENT

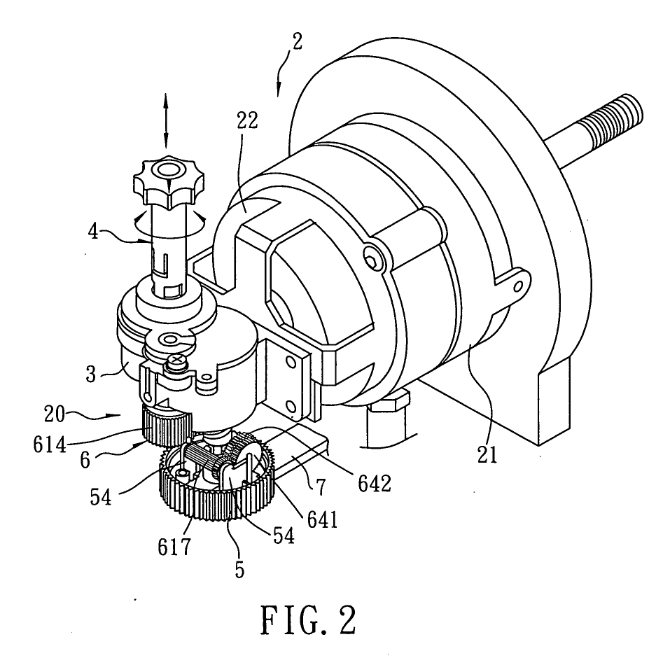

Referring to FIGS. 2, 3, and 4, the preferred embodiment of a fan-oscillating device 20 according to this invention includes an electrical motor 22 and a fan head 2. The electrical motor 22 is mounted within a motor seat 21 disposed on the fan head 2, and is provided with a motor shaft 221. The fan-oscillating device 20 includes a housing unit 3, a control mechanism 4, a rotatable wheel 5, a link-operating unit 6, and a link 7.

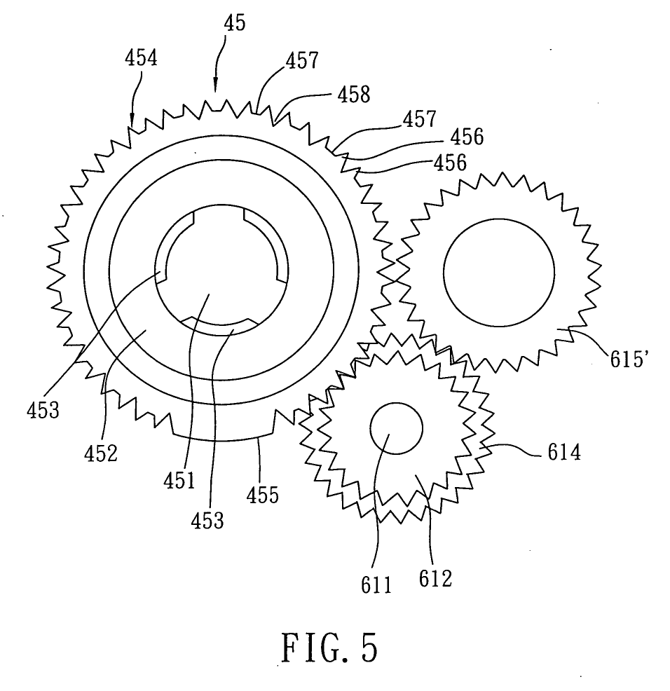

With further reference to FIG. 5, the housing unit 3 is mounted to and disposed behind the motor seat 21, and includes a housing 31, and a top cover 32 connected threadedly to an upper end of the housing 31. The housing 31 includes an upright mounting wall 311 mounted fixedly to the fan head 2, a surrounding wall 313 formed integrally with the mounting wall 311 to define an accommodating chamber 312 thereamong, a pair of first and second through holes 316, 316′ formed in a bottom wall 317, a tube 318 formed integrally with a bottom surface of the bottom wall 317 and communicated with the first through hole 316, and an insert rod 319, an upper end of which is formed integrally with the bottom wall 317 and has an externally threaded rod portion 310. The top cover 32 is used to cover the accommodating chamber 312, and has a positioning portion 322 and a pivot hole 320 aligned respectively and vertically with the first and second through holes 316, 316′.

The control mechanism 4 includes an upright clutch rod 41, an upright control rod 42 aligned with the clutch rod 41, a motor-connecting member 43 sleeved rotatably on the clutch rod 41, a positioning unit 44, a driving gear 45, and a graduated disk 46 sleeved on the control rod 42 and having a top surface that is indicated with three angle marks 20°, 60°, and 90°.

An upper end of the clutch rod 41 is journalled within the positioning portion 322 of the top cover 32. A lower end of the clutch rod 41 extends through the first through hole 316 in the housing 31 and the tube 318 of the housing 31. The clutch rod 41 includes a toothed annular outer surface 411 disposed at a lower end thereof, an annular groove 412 formed in an upper end portion thereof, and an outward flange 413 extending radially and outwardly from the clutch rod 41 and disposed between the toothed annular outer surface 411 and the annular groove 412. The outward flange 413 has a hole 414 formed therethrough. The positioning unit 44 includes a coiled compression spring 441 disposed within the hole 414 in the outward flange 413, and two balls 442 disposed within the hole 414 and biased by the spring 441 to project outwardly from the hole 414 away from each other.

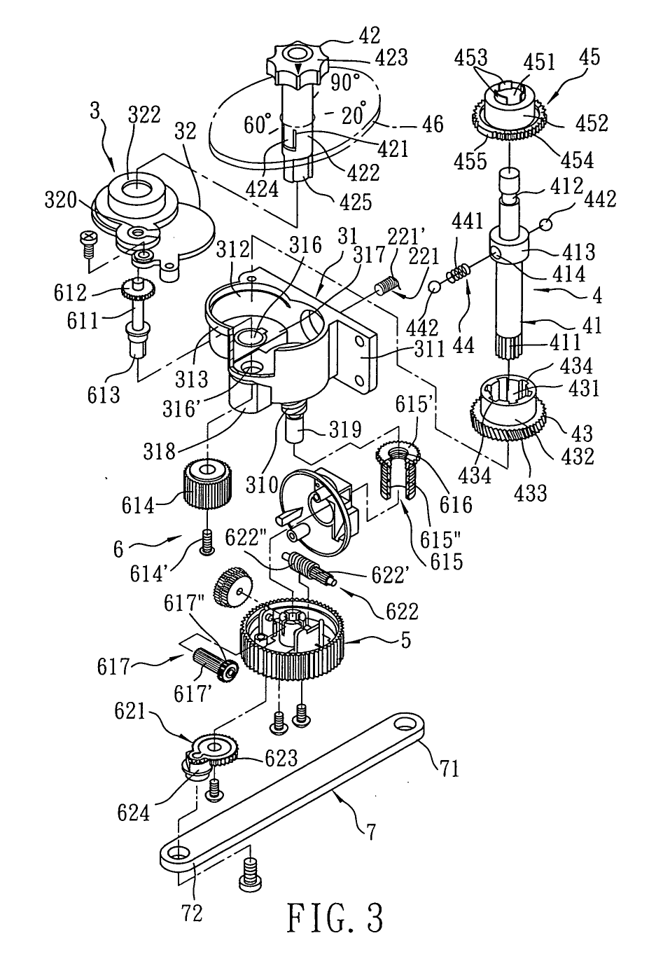

The control rod 42 has a hollow lower portion 422, an upper end rotary button 423 for manual operation, and two U-shaped slots 421 (only one is shown in FIG. 3) formed in an annular wall and disposed at an upper end of the hollow lower portion 422 so as to define two aligned resilient plate portions 424 (only one is shown in FIG. 3). The lower portion 422 is formed with a plurality of axially extending slots 425 in a lower end thereof. The rotary button 423 is indicated with an arrow that is rotatable to be aligned with a selected one of the angle marks 20°, 60°, and 90°. Each of the plate portions 424 is formed with a projection 426 extending radially and inwardly therefrom. The projections 426 extend toward each other, and engage the annular groove 412 in the clutch rod 41. This allows for synchronous axial movement and relative rotation of the clutch rod 41 and the control rod 42 while preventing separation of the clutch rod 41 and the control rod 42.

The motor-connecting member 43 is disposed rotatably in the housing unit 3, and has a central hole 431 defined by an annular wall 432, and a bevel gear portion 433 disposed at a lower end of the motor-connecting member 43. The annular wall 432 has an inner surface that is formed with a plurality of axially extending slots 434, each of which has two open ends. The bevel gear portion 433 engages a gear portion 221′ (see FIG. 3) of the motor shaft 221. Thus, rotation of the motor shaft 221 can be transferred to the motor-connecting member 43.

The driving gear 45 is disposed rotatably within the positioning portion 322 of the top cover 32, and has a central hole 451 defined by an annular wall 452, and a bottom surface in slidable contact with an upper end of the motor-connecting member 43. The clutch rod 41 extends through the driving gear 45 and the motor-connecting member 43, and is disposed movably and rotatably within the driving gear 45. The annular wall 452 has an upper end formed with a plurality of upwardly and axially extending tongues 453 engaging respectively with the slots 425 in the control rod 42 so as to allow for co-rotation of the driving gear 45 and the control rod 42. The driving gear 45 has a lower end flange that is formed with a toothed surface portion 454 and a smooth surface portion 455 connected to the tooth surface portion 454 along a circumferential direction of the driving gear 45.

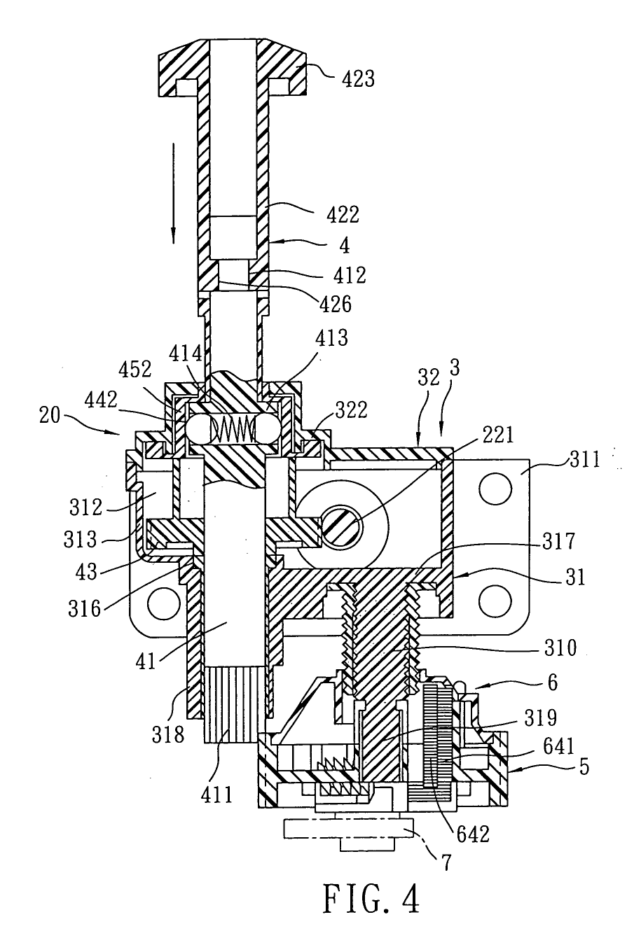

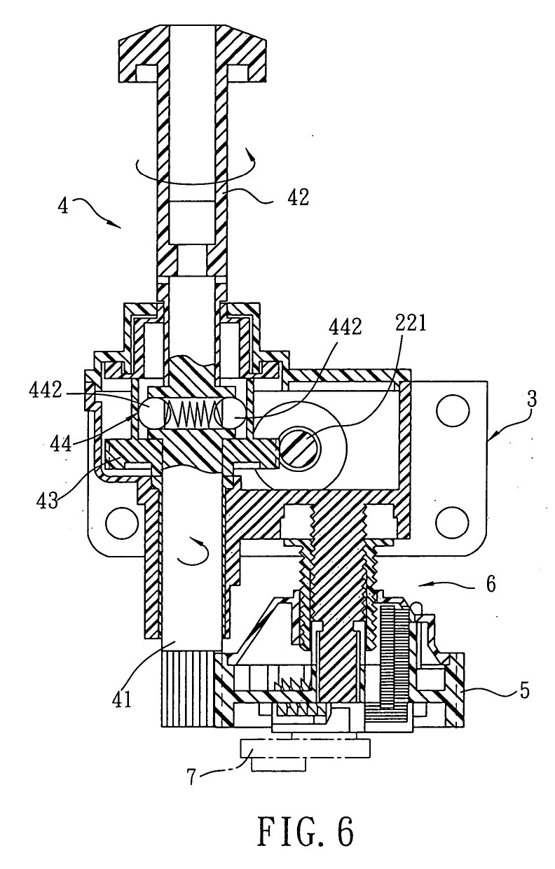

The control rod 42 is movable vertically relative to the housing 31 between a disengagement position shown in FIG. 4 and an engagement position shown in FIG. 6, and is rotatable about a central axis of the control rod 42 itself. When the control rod 42 is disposed in the engagement position, the balls 442 engage respectively the slots 434 in the motor-connecting member 43 so as to allow for synchronous rotation of the clutch rod 41 and the motor-connecting member 43. In this state, when the motor 22 is started, rotation of the motor-connecting member 43 is transferred to the clutch rod 41. When the control rod 41 is moved downwardly to the disengagement position, the balls 442 are removed from the slots 434 in the motor-connecting member 43 to thereby contact an inner surface of the driving gear 45. In this state, rotation of the motor-connecting member 43 cannot be transferred to the clutch rod 41.

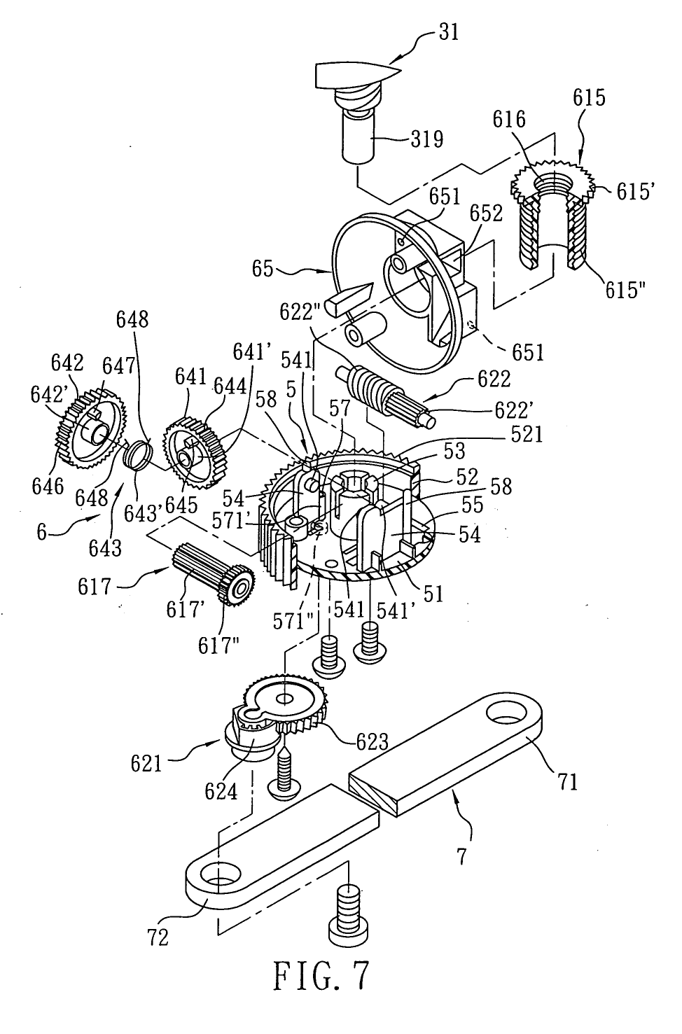

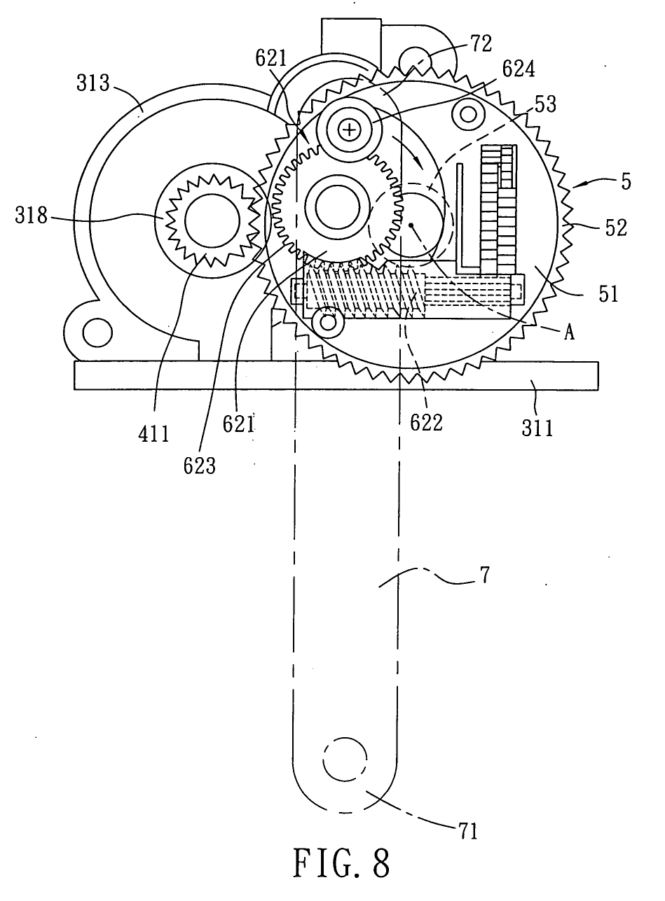

With additional reference to FIGS. 7 and 8, the rotatable wheel 5 includes a horizontal circular base wall 51, a toothed annular wall 52 formed integrally with a periphery of the base wall 51 and having a toothed annular outer surface 521, a central tube 53 extending integrally from the center of the base wall 51 for insertion of the insert rod 319 of the housing 31 thereinto, two upright wall units 54 extending integrally and upwardly from the base wall 51, two pivot stubs 541 extending respectively from the upright wall units 54 toward each other, a pivot pin 541′ extending from one of the upright wall units 54 and parallel to the pivot stubs 541, a recess 55 formed in a top surface of the base wall 51, a pivot tube unit 57 having an upper tube portion 571′ extending upwardly from the base wall 51 and a lower tube portion 571″ extending downwardly from the base wall 51, and two positioning pins 58 projecting respectively, integrally, and upwardly from the base wall 51 and one of the upright wall units 54. The toothed annular outer surface 521 of the toothed annular wall 52 engages the toothed annular outer surface 411 of the clutch rod 41. As such, when the motor 22 is in operation and when the control rod 42 is disposed in the engagement position, the rotatable wheel 5 rotates about the insert rod 319 of the housing 31.

The link-operating unit 6 includes a rotating shaft 611, a driven gear 612, a spur gear 614, a first drive member 615, a second drive member 617, a first drive gear 641, a second drive gear 642, a precompressed torsional spring 643, a third drive member 622, a link-connecting member 621, and a positioning cover 65.

The rotating shaft 611 is journalled on an inner surface of the housing 31. The driven gear 612 is sleeved fixedly on an upper end of the rotating shaft 611, and is formed with an annular toothed surface engaging the toothed surface portion 454 of the driving gear 45, as shown in FIG. 5. The rotating shaft 611 has a lower end 613 that is formed with a threaded hole (not shown) and that is disposed rotatably within the second through hole 316′ in the housing 31. The spur gear 614 is journalled on an outer surface of the housing 31, and is connected coaxially and fixedly to the rotating shaft 611 by means of a bolt 614′ such that the spur gear 614 is co-rotatable with the rotating shaft 611 and the driven gear 612.

The first drive member 615 has an internally threaded portion 616 engaging the externally threaded rod portion 310 of the housing 31, an annular tooth portion 615′ engaging the spur gear 614, and an externally threaded portion 615″.

The second drive member 617 is sleeved on the pivot stubs 54 of the rotatable wheel 5, and is perpendicular to the externally threaded rod portion 310 of the housing 31. A thin externally toothed portion 617′ of the second drive member 617 engages the externally threaded portion 615″ of the first drive member 615.

Each of the first and second drive gears 641, 642 is formed with an integral central sleeve 641′, 642′ sleeved rotatably on the pivot pin 541′ of the rotatable wheel 5, an annular toothed surface 644, 646, and an integral stop rod 645, 647. The toothed surface 644 of the first drive gear 641 engages a thick externally toothed portion 617″ of the second drive member 617.

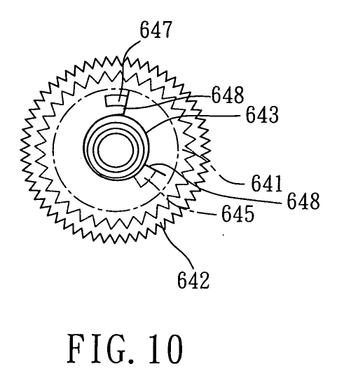

The torsion spring 643 has a coiled spring portion 643′ sleeved on the central sleeves 641′, 642′ of the first and second drive gears 641, 642; and two ends 648 abutting respectively against the stop rods 645, 647 of the first and second drive gears 641, 642 so as to bias the second drive gear 642 to rotate relative to the first drive gear 641 to a predetermined position shown in FIG. 11.

The third drive member 622 is journalled within the recess 55 in the rotatable wheel 5, and has an externally toothed portion 622′ engaging the toothed surface 646 of the second drive gear 642, and a worm rod portion 622″.

The link-connecting member 621 is sleeved rotatably on the lower tube portion 571″ of the pivot tube unit 57, and is formed with a circumferential row of teeth 623 and an eccentric portion 624. The teeth 623 engage the worm rod portion 622″ of the third drive member 622.

The link 7 has a first end 71 connected pivotally to the fan head 2, and a second end 72 connected pivotally to the eccentric portion 624 of the link-connecting member 621.

The positioning cover 65 is disposed on the rotatable wheel 5, and is formed with two pinholes 651 and a confining recess 652. The positioning pins 58 of the rotatable wheel 5 engage respectively the pinholes 651 in the positioning cover 65 so as to position the positioning cover 65 on the rotatable wheel 5. The first and second drive gears 641, 642 and the torsional spring 643 are confined within the confining recess 652 in the positioning cover 65.

When the control rod 42 is disposed in the disengagement position, and when the motor 22 is in operation, while the motor-connecting member 43 rotates, the clutch rod 41 and the rotatable wheel 5 are unable to rotate. When the control rod 42 is disposed in the engagement position, and when the motor 22 is in operation, the rotatable wheel 5 is rotated about the insert rod 319 in a direction, as described above, and the link-connecting member 621 is also rotated about the insert rod 319 in the direction. Hence, the link 7 oscillates the fan head 2.

When it is desired to adjust the oscillation angle of the fan head 2, the control rod 42 is rotated about its central axis. Rotation of the control rod 42 is transferred to the link-connecting member 621 via a transmission line formed by the driving gear 45, the driven gear 612, the spur gear 614, the first driving member 615, the second drive member 617, the first drive gear 641, the second drive gear 642, and the third drive member 622. As a consequence, the link-connecting member 621 rotates about the pivot tube unit 57. With additional reference to FIGS. 8 and 9, when the control rod 42 is rotated clockwise, the eccentric portion 624 of the link-connecting member 621 pivots away from the rotating axis (A) of the link-connecting member 621. This change in the radial position of the eccentric portion 624 of the link-connecting member 621 increases the oscillation angle of the fan head 2. When the control rod 42 is rotated counterclockwise, the eccentric portion 624 of the link-connecting member 621 pivots toward the rotating axis (A) of the link-connecting member 621. This reduces the oscillation angle of the fan head 2.

In the transmission line, the precompressed torsional spring 643 is disposed between the first and second drive gears 641, 642. As such, transfer of rotation from the first drive gear 641 to the second drive gear 642 is allowed, while transfer of rotation from the second drive gear 642 to the first drive gear 641 is prevented. Thus, even when the fan head 2 is oscillating, the control rod 42 can be rotated so as to adjust the oscillation angle of the fan head 2.

Since the toothed surface portion 454 of the driving gear 45 has two ends that are spaced apart from each other by the smooth surface 455, the rotation angle of the control rod 42 is limited to be smaller than 360°. Thus, the eccentric portion 624 of the link-connecting member 621 is pivotable on the rotatable wheel 5 between two positions shown in FIGS. 8 and 9. As a consequence, the oscillation angle of the fan head 2 is adjustable between a maximum angle and a minimum angle.

The toothed surface portion 454 of the driving gear 45 is formed with interconnected teeth 456, which engage the driven gear 612, as described above, and which define a plurality of alternately arranged shallow and deep tooth valleys 457, 458. As such, synchronous rotation of the driving gear 45 and the clutch rod 41 as result of frictional contact therebetween can be prevented.

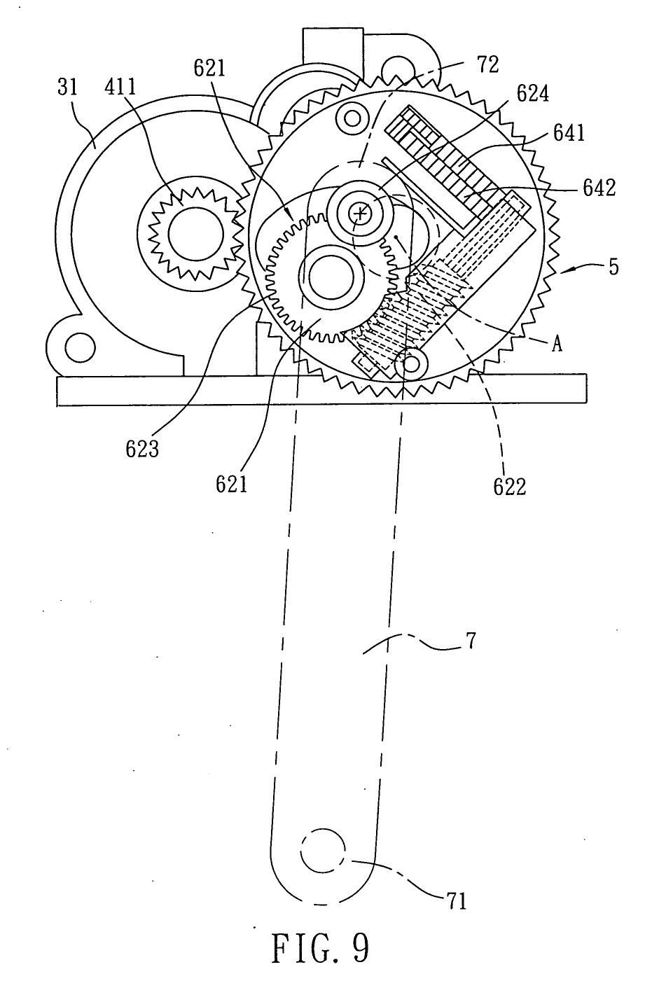

During assembly, the torsional spring 643 is initially placed between the first and second drive gears 641, 642 such that it is not compressed, as shown in FIG. 10. Subsequently, the second drive gear 642 is rotated relative to the first drive gear 641 to a predetermined position shown in FIG. 11, where the torsional spring 643 is compressed and where the stop rods 645, 647 are aligned with each other in a radial direction of the first and second drive gears 641, 642.

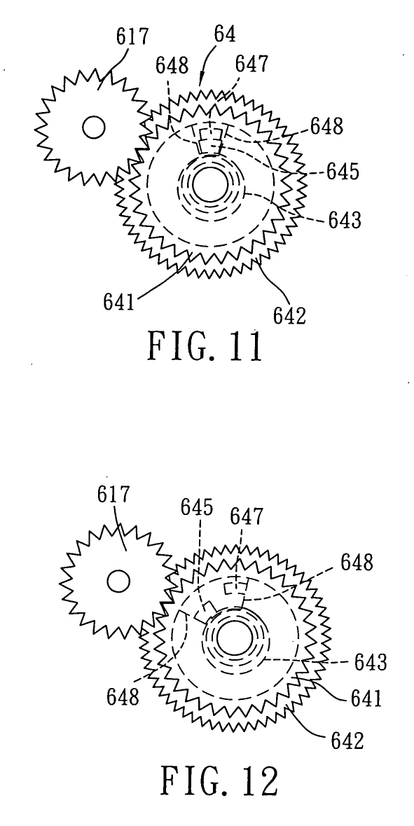

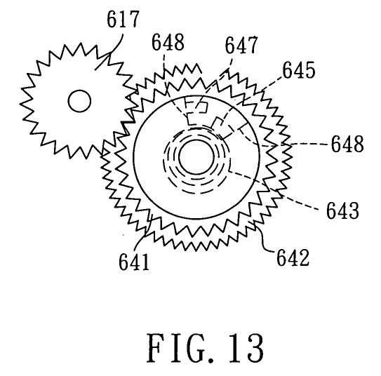

As such, the first drive gear 641 can rotate relative to the second drive gear 642 in a counterclockwise direction, as shown in FIG. 12, or in a clockwise direction, as shown in FIG. 13. This allows for rotation of the control rod 42 when the fan head 2 oscillates. Due to the presence of the torsion spring 643, when an external force applied is released, the first drive gear 641 is returned from the position shown in FIG. 12 or 13 to that shown in FIG. 11.

With this invention thus explained, it is apparent that numerous modifications and variations can be made without departing from the scope and spirit of this invention. It is therefore intended that this invention be limited only as indicated by the appended claims.

I claim:

1. A fan-oscillating device adapted to interconnect an electrical motor and a fan head, said fan-oscillating device comprising:
a housing unit adapted to be mounted to the fan head;
a control mechanism including an upright control rod that is movable relative to said housing unit between an engagement position and a disengagement position and that is rotatable about a central axis of said control rod;
a rotatable wheel disposed rotatably on said housing unit and adapted to be rotated by the motor only when said control rod is disposed in said engagement position;
a link-operating unit including a link-connecting member that is disposed rotatably on said rotatable wheel and that has an eccentric portion; and
a link having a first end adapted to be connected pivotally to the fan head, and a second end connected pivotally to said eccentric portion of said link-connecting member;
said control rod of said control mechanism being connected to said link-connecting member such that said control rod is rotatable about said central axis thereof so as to rotate said link-connecting member relative to said rotatable wheel, thereby adjusting a distance between said eccentric portion of said link-connecting member and a rotating axis of said rotatable wheel, which results in a change to an oscillation angle of the fan head.

2. The fan-oscillating device as claimed in claim 1, wherein said control mechanism further includes:
an annular motor-connecting member disposed rotatably in said housing unit and adapted to be rotated by the motor, said motor-connecting member having an inner surface that is formed with at least one axially extending slot, which has two open ends;
an upright clutch rod disposed movably and rotatably in said housing unit and extending through said motor-connecting member, said clutch rod being connected to said control rod so as to allow for synchronous axial movement and relative rotation of said control rod and said clutch rod while preventing separation of said control rod and said clutch rod;
at least one spring-biased ball disposed on said clutch rod and engaging said slot in said motor-connecting member so as to allow for synchronous rotation of said clutch rod and said motor-connecting member when said control rod is disposed in said engagement position, rotation of said clutch rod being transferred to said rotatable wheel, said spring-biased ball being removed from said slot in said motor-connecting member when said control rod moves to said disengagement position.

3. The fan-oscillating device as claimed in claim 2, wherein said rotatable wheel is formed with a toothed annular outer surface, said clutch rod having a lower end that is formed with a toothed annular outer surface, which engages said toothed annular outer surface of said rotatable wheel so as to allow for rotation of said rotatable wheel when said control rod is disposed in said engagement position and when the motor is in operation.

4. The fan-oscillating device as claimed in claim 2, wherein said clutch rod has an upper end portion that is formed with an annular groove, said control rod having an annular wall that is formed with two U-shaped slots, which define two aligned resilient plate portions, each of said plate portions being formed with a projection extending radially and inwardly therefrom, said projections extending toward each other and engaging said annular groove in said upper end portion of said clutch rod so as to allow for synchronous axial movement of said control rod and said clutch rod and relative rotation between said control rod and said clutch rod.

5. The fan-oscillating device as claimed in claim 2, wherein said control mechanism further includes an annular driving gear disposed rotatably within said housing unit, said clutch rod extending through and being disposed movably and rotatably within said driving gear, said driving gear being co-rotatable with said control rod and having an annular surface that is formed with a toothed surface portion and a smooth surface portion connected to said toothed surface portion along a circumferential direction of said driving gear;
said link-operating unit includes a driven gear formed with an annular toothed surface engaging said toothed surface portion of said annular surface of said driving gear so as to limit a rotation angle of said control rod to be smaller than a predetermined angle, said predetermined angle being smaller than 360 degrees, rotation of said driven gear being transferred to said link-connecting member so as to pivot said link-connecting member relative to said rotatable wheel, thereby changing a radial position of said eccentric portion of said link-connecting member relative to said rotatable wheel and, thus, the oscillation angle of the fan head.

6. The fan-oscillating device as claimed in claim 5, wherein said control rod has an end that is formed with a plurality of axially extending slots, and said driving gear is formed with a plurality of axially extending tongues engaging respectively said slots in said control rod so as to allow for co-rotation of said driving gear with said control rod.

7. The fan-oscillating device as claimed in claim 5, wherein said housing unit includes an externally threaded rod portion disposed fixedly thereon, said link-connecting member being formed with a circumferential row of teeth, said link-operating unit further including:
a rotating shaft journalled on an inner surface of said housing unit, said driven gear being sleeved fixedly on said rotating shaft;
a spur gear journalled on an outer surface of said housing unit and connected coaxially and fixedly to said rotating shaft;
a first drive member having an internally threaded portion engaging said externally threaded rod portion of said housing unit, an annular toothed portion engaging said spur gear so as to allow for transfer of rotation from said spur gear to said first drive member, and an externally threaded portion;
a second drive member journalled on said rotatable wheel and perpendicular to said externally threaded rod portion of said housing unit, said second drive member having a thin externally toothed portion engaging said externally threaded portion of said first drive member;
a third drive member journalled on said rotatable wheel and connected to said second drive member so as to allow for transfer of rotation from said second drive member to said third drive member, said third drive member having a worm rod portion engaging said teeth of said link-connecting member so as to allow for transfer of rotation from said third drive member to said link-connecting member.

8. The fan-oscillating device as claimed in claim 7, wherein said second drive member further has a thick externally toothed portion thicker than said thin externally toothed portion, said third drive member having an externally toothed portion, said link-operating unit further including:
a first drive gear disposed rotatably on said rotatable wheel and formed with an annular toothed surface engaging said thick externally toothed portion of said second drive member so as to allow for transfer of rotation from said second drive member to said first drive gear;
a second drive gear disposed rotatably on said rotatable wheel and formed with an annular toothed surface engaging said externally toothed portion of said third drive member so as to allow for transfer of rotation from said second drive gear to said third drive member; and
a precompressed torsional spring disposed between said first and second drive gears so as to allow for transfer of rotation from said first drive gear to said second drive gear, while preventing transfer of rotation from said second drive gear to said first gear;
whereby, when said motor is in operation and when said control rod is disposed in said engagement position so as to rotate said rotatable wheel and, thus, said eccentric portion of said link-connecting member relative to said housing unit, said control rod can be rotated relative to said housing unit so as to adjust the oscillation angle of the fan head.

9. The fan-oscillating device as claimed in claim 8, wherein said rotatable wheel is formed with an integral pivot pin, each of said first and second drive gears being formed with an integral stop rod and an integral central sleeve sleeved rotatably on said pivot pin of said rotatable wheel, said torsional spring having a coiled spring portion sleeved on said central sleeves of said first and second drive gears, and two ends abutting respectively against said stop rods of said first and second drive gears so as to bias said second drive gear to rotate relative to said first drive gear to a predetermined position.

10. The fan-oscillating device as claimed in claim 8, wherein said stop rods are aligned with each other in a radial direction of said first and second drive gears when said second drive gear is disposed in the predetermined position.

11. The fan-oscillating device as claimed in claim 5, wherein said tooth surface portion of said driving gear is formed with a plurality of interconnected teeth, which define a plurality of alternately arranged shallow and deep tooth valleys.
